(19) United States
(12) Patent Application Publication
(10) Pub. No.: US 2007/0259154 A1
(43) Pub. Date: Nov. 8, 2007

(54) Apertured film and Method for Making

(76) Inventor: James W. Cree, Chesterfield, VA (US)

Correspondence Address: JOSEPH E. CHOVANES, SUITE 329, 5 GREAT VALLEY PARKWAY, MALVERN, PA, 19355, US

(21) Appl. No.: 11/744,067

(22) Filed: May 3, 2007

Related U.S. Application Data
(60) Provisional application No. 60/797,089, filed on May 3, 2006.

(51) Int. Cl. B32B 3/10

(52) U.S. Cl. 428/131

(57) ABSTRACT

A three dimensional apertured film and methods of making said film are disclosed, as well as articles comprising said film. Methods for making said film comprise using counter rotating cylinders and a support web, so that said film is apertured using perforation means on a counter rotating cylinder.

### CROSS REFERENCE TO RELATED APPLICATIONS

This application claims priority from U.S. Ser. No. 60/797,089, filed May 3, 2006.

### FIELD OF THE INVENTION

The present invention relates to apertured film and methods for making such film.

### BACKGROUND OF THE INVENTION

Apertured films are used in various industrial and consumer products sectors. For example, apertured films are used to produce disposable sheets, disposable garments and hygiene and sanitary products, such as sanitary napkins, incontinence pads and baby diapers.

Apertured films can be manufactured using various techniques. For example, one technique for forming apertured film entails extruding a plastic sheet of film using traditional film extrusion techniques (for example, a thin sheet of LDPE delivered through a cast or blown extrusion head,) and aperturing the film using solid or molten phase forming techniques as known in the art (e.g., water perforation techniques, mechanical perforation techniques, etc.) The film may be textured as well the film via mechanical or water embossing, or other methods as are known in the art.

### BRIEF DESCRIPTION OF THE DRAWINGS

FIG. 1 shows an embodiment.

FIG. 2 shows another view of the embodiment of FIG. 1.

FIG. 3 shows a view of a nonwoven embodiment.

FIG. 4 shows a view of another embodiment.

### DETAILED DESCRIPTION OF THE EMBODIMENTS

The present invention relates to apertured film and methods for making such film.

Method embodiments comprise aperturing a film using a support web, so that the apertured film may have more defined apertures than may otherwise be present (that is, then may otherwise be present without a support web.)

Article embodiments comprise film with three dimensional apertures.

Preferred method embodiments comprise:
Texturing the film through embossing techniques as known in the art (e.g., generating a texture using vacuum, calendar embossing, etc.);
Aperturing a film through feeding the textured film, along with a support web, into a nip. The nip comprises two counter rotating cylinders: one counter rotating cylinder has an engraved surface with perforation means as are known in the art, e.g. protrusions, etc., and the second counter rotating cylinder has a smooth surface. The film, along with a support web, passes through the nip and is perforated according to the surface on the counter rotating cylinder.
Separating the film from the support web, without destroying the support web. (Embodiments may destroy the support web, however, such destruction may lead to pollution of the film with fragments of the web which is usually less than desirable.)

The film of the preferred embodiments is preferably a thermoplastic as known in the art. The support web is preferably an inert material as is known in the art.

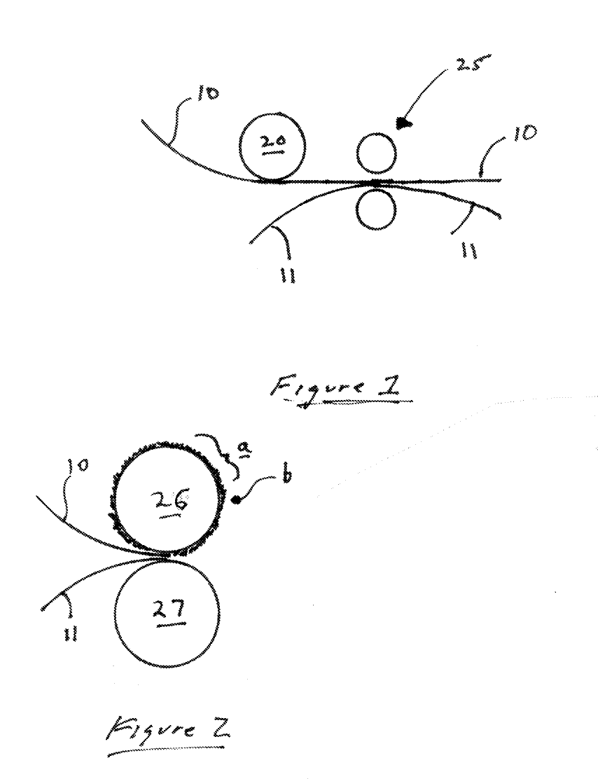

Turning now to FIG. 1, a preferred embodiment is shown. A 25 GSM thermoplastic film 10, as known in the art, is fed into vacuum embossing cylinder 20 and so is embossed or textured with a three dimensional raised structure, as is known in the art.

Film 10 is fed into nip 25 along with a 16 GSM thermobonded nonwoven 11 which is a polypropylene nonwoven in this embodiment and is provided here as an inert support web. Other embodiments may provide other inert support webs. Both film 10 and nonwoven 11 may be positioned above or below the other, as long as the remaining apparatus is positioned accordingly. In the preferred embodiments, nonwoven 11 is fed below the film 10.

Turning to FIG. 2, nip 25 is seen, comprised of counter rotating cylinder 26 and counter rotating cylinder 27. On counter rotating cylinder 26, engraved surface a, with protrusions shown generally at b, is shown. Film 10 and nonwoven 11 feeds into nip 25, with film 10 contacting counter rotating cylinder 26 and engraved surface a. The protrusions, shown generally at b, perforate film 10. Protrusions b also pass through film 10 and contact surface of nonwoven 11, however, due to the nature of the nonwoven, protrusions b do not damage (i.e., make unusable) nonwoven 11. It should be noted that film 10 remains in a solid state during travel through nip 25, and the differential speed between the upper cylinder 26 with the protrusions and the smooth cylinder 27 cause the film 10 to become semi molten and that said protrusions, as they pass through the film 10 into nonwoven 11, cause film 10 to stick at least slightly onto nonwoven 11, and thus produce a more useful aperture in film 10 than might otherwise occur. In effect, the nonwoven 11 is acting as a support structure.

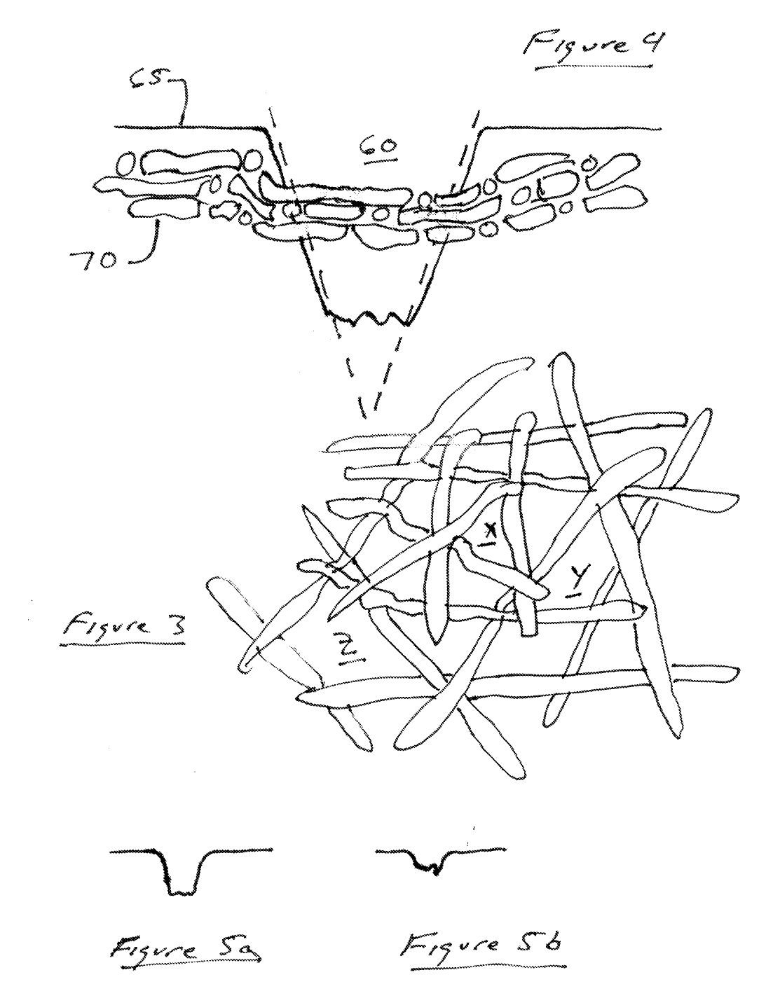

Turning briefly to FIG. 3, a view of a nonwoven is shown. Areas x, y and z provide spaces for protrusions such as those labeled b in FIG. 2, to penetrate.

Turning to FIG. 4, a view is shown of a protrusion 60, proceeding from roller 61, penetrating through film 65 and non woven 70. Edges of film 65 are shown being carried into nonwoven 70. As edges 65 are carried into nonwoven 70 they stick briefly, thus providing a more defined or formed cone than otherwise might be instanced, as the semi-molten film 65 remained stuck to nonwoven 70 for a dwell time rather than being pulled by exiting protrusion 60 back into the plane of film 65. Thus, nonwoven 70 has helped form an aperture or cone in the film. A comparison of such a cone, with one formed without the support of a web, is shown at FIGS. 5a and 5b, where 5a is formed in accordance with a preferred embodiment.

Returning now to FIG. 1, as film 10 and nonwoven 11 exit nip 25, film 10 and nonwoven 11 are separated. Film 10 may be used as desired. Nonwoven 11 may be used as desired as well.

Texturing and aperturing may be as desired. For example, patterns may be provided through either or both texturing and aperturing. Embodiments may also provide for longer dwell time, that is, the time during which a film remains stuck to a support web, through varying parameters such as support web material, molten state of a film, application of heat and/or pressure during the nip process, etc.

It should be noted as well that embodiments may provide for varying sizes, shapes, etc. in whole or part of apertures through varying dwell time or other parameters in various embodiments. For example, an aperture shape may be defined in part in certain embodiments through a relatively long dwell time if desired, a shorter time would, in certain embodiments provide a less defined aperture shape, etc.

A film formed in accordance with embodiments may be used as desired. For example, various embodiments may be used, in whole or part, in various types of articles, such as, for example, a top sheet or other parts of absorbent articles, including adult, child or infant incontinence products (for example, diapers, briefs, etc.,) female hygiene products (for example, female menstrual products, sanitary napkins, pantiliners, etc.,) wraps, including sterile and nonsterile (e.g. bandages with and without absorbent sections,) as well as other disposable and/or multiple use products; e.g., articles proximate to a human or animal body, such as for example, garments, apparel, including undergarments, under- and outer-wear, for example, undershirts, bras, briefs, panties, etc., bathing suits, coveralls, socks, head coverings and bands, hats, mitten and glove liners, medical clothing, etc.; bed sheets; medical drapes; packaging materials; protective covers; household; office; medical or construction materials; wrapping materials; etc. therapeutic devices and wraps.

Further treatment may also be desired, such as supplementary bonding processes, embossing processes, perforation processes, mechanical activation processes, combinations of these, etc.

Embodiments may also be combined with a component or components to form laminate or composite materials, finished and semi-finished, etc. which, if desired, may be further treated through embossing, perforating etc. sewing, bonding, printing, cutting, shaping, gluing, fluting, sterilizing, etc. combination with or independently of other processes as are known in the art.

Although the present invention has been described with respect to various specific embodiments, various modifications will be apparent from the present disclosure and are intended to be within the scope of the following claims.

I claim:

1) A method for making an apertured film comprising:
feeding a film and a support web, into a nip, where said nip comprises a first and second cylinders, with said first cylinder having an engraved surface with at least one perforation means and said second cylinder having a smooth surface, so that said film is apertured by said at least one perforation means on said first cylinder, and, as said perforation means is being withdrawn from said film, said film remains stuck to said support web for a dwell time.

2) A method for making an apertured film as in claim 1 further comprising texturing said film.

3) A method for making an apertured film as in claim 1 further comprising separating said film and said support web.

4) A method for making an apertured film as in claim 1 wherein said film further comprise a thermoplastic film.

5) A method for making an apertured film as in claim 1 wherein said support web further comprise a polypropylene nonwoven.

6) A method for making an apertured film as in claim 1 wherein said first and second cylinders further comprise a first and second counter rotating cylinder.

7) A method for making an apertured film as in claim 1 further comprising aperturing said film.

8) A method for making an apertured film as in claim 1 further comprising patterning said film.

9) A method for making an apertured film as in claim 1 further comprising lengthening said dwell time through varying parameters, wherein said parameters are selected from a group consisting of support web material, molten state of a film, application of heat during the nip process and varying pressure during the nip process.

10) A method for making an apertured film as in claim 1 further comprising varying shapes, in whole or part, of apertures through varying said dwell time.

11) A method for making an apertured film as in claim 1 further comprising varying sizes, in whole or part, of apertures through varying said dwell time or other parameters in various embodiments.

12) A method for making an apertured film as in claim 1 further comprising further treatment of said film wherein said further treatment is selected from the group comprising supplementary bonding processes, embossing processes, perforation processes, and mechanical activation processes.

13) A method for making an apertured film as in claim 1 further comprising forming laminate materials with said film.

14) A method for making an apertured film as in claim 1 further comprising forming composite materials with said film.

15) A film made by the method of claim 1.

16) A film having a three dimensional aperture, wherein said aperture is made by feeding said film and a support web, into a nip, where said nip comprises a first and second cylinders, with said first cylinder having an engraved surface with at least one perforation means and said second cylinder having a smooth surface, so that said film is apertured by said at least one perforation means on said first cylinder, and, as said perforation means is being withdrawn from said film, said film remains stuck to said support web for a dwell time.

17) An article comprising:
a film having a three dimensional aperture, wherein said aperture is made by feeding said film and a support web, into a nip, where said nip comprises a first and second cylinders, with said first cylinder having an engraved surface with at least one perforation means and said second cylinder having a smooth surface, so that said film is apertured by said at least one perforation means on said first cylinder, and, as said perforation means is being withdrawn from said film, said film remains stuck to said support web for a dwell time;
wherein said article is selected from the group comprising absorbent articles, female hygiene products, wraps, garments, apparel, bed sheets, medical drapes, packaging materials, protective covers, household, office, medical materials, construction materials, wrapping materials, and therapeutic devices.

18) A top sheet of an absorbent article comprising a film having a three dimensional aperture, wherein said aperture is made by feeding said film and a support web, into a nip, where said nip comprises a first and second cylinders, with said first cylinder having an engraved surface with at least one perforation means and said second cylinder having a smooth surface, so that said film is apertured by said at least one perforation means on said first cylinder, and, as said perforation means is being withdrawn from said film, said film remains stuck to said support web for a dwell time.
